(19) United States
(12) Patent Application Publication
(10) Pub. No.: US 2026/0122293 A1
(43) Pub. Date: Apr. 30, 2026

(54) REALTIME TRANSLATION OF COMMUNICATIONS EMBEDDED IN STREAMING VIDEO

(71) Applicant: Charter Communications Operating, LLC, St. Louis, MO (US)

(72) Inventor: Jeremy P. Meissner, Parker, CO (US)

(21) Appl. No.: 18/927,237

(22) Filed: Oct. 25, 2024

(51) Int. Cl. H04N 21/23; G06F 40/40; H04N 21/43

(52) U.S. Cl. CPC H04N 21/23; G06F 40/40; H04N 21/2335; H04N 21/2355; H04N 21/4884; H04N 21/4302

(57) ABSTRACT

A client computing device receives from a streaming computing system an encoded packet in a stream of encoded packets, the stream of encoded packets comprising encoded video content of a program. It is determined that the encoded packet comprises closed caption text in a first language. The closed caption text in the first language is caused to be translated to closed caption text in a second language. A modified encoded packet that includes the closed caption text in the second language is generated, and sent to a decoder for decoding.

### BACKGROUND

Streaming video content often includes multiple types of communications, such as a primary audio track, subtitles, closed captions, audio description and the like.

### SUMMARY

The examples disclosed herein implement realtime translation of communications embedded in streaming video.

In one implementation a method is provided. The method includes receiving, by a client computing device from a streaming computing system, an encoded packet in a stream of encoded packets, the stream of encoded packets comprising encoded video content of a program. The method further includes determining, by the client computing device, that the encoded packet comprises closed caption text in a first language. The method further includes extracting, by the client computing device from the encoded packet, the closed caption text in the first language. The method further includes causing, by the client computing device, the closed caption text in the first language to be translated to closed caption text in a second language. The method further includes generating, by the client computing device, a modified encoded packet that includes the closed caption text in the second language. The method further includes sending, by the client computing device, the modified encoded packet to a decoder for decoding.

In another implementation a computing system is provided. The computing system includes one or more computing devices operable to receive, from a streaming computing system, an encoded packet in a stream of encoded packets, the stream of encoded packets comprising encoded video content of a program. The one or more computing devices are further operable to determine that the encoded packet comprises closed caption text in a first language. The one or more computing devices are further operable to extract, from the encoded packet, the closed caption text in the first language. The one or more computing devices are further operable to cause the closed caption text in the first language to be translated to closed caption text in a second language. The one or more computing devices are further operable to generate a modified encoded packet that includes the closed caption text in the second language. The one or more computing devices are further operable to send the modified encoded packet to a decoder for decoding.

In another implementation a method is provided. The method includes receiving, by a client computing device from a streaming computing system, an encoded packet in a stream of encoded packets, the stream of encoded packets comprising digitized audio signals that comprise a narration of scenes in a program that is being streamed to client computing device. The method further includes extracting, by the client computing device from the encoded packet, first audio signals in a first language. The method further includes causing, by the client computing device, the first audio signals to be translated to second audio signals in a second language. The method further includes generating, by the client computing device, a modified encoded packet that includes the second audio signals. The method further includes sending, by the client computing device, the modified encoded packet to a decoder for decoding.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment suitable for implementing realtime translation of communications embedded in streaming video according to some implementations;

FIG. 2 is a flowchart of a method for implementing realtime translation of communications embedded in streaming video according to some implementations;

FIG. 3 is a block diagram of an environment suitable for implementing realtime translation of communications embedded in streaming video according to some implementations;

FIG. 4 is a flowchart of a method for implementing realtime translation of communications embedded in streaming video according to another implementation; and

FIG. 5 is a block diagram of a client computing device suitable for implementing examples disclosed herein according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Streaming video content associated with a program typically includes, in addition to the primary audio soundtrack, one or more additional communication options such as closed caption text and/or audio description. Closed caption text (sometimes referred to herein as closed captions for the sake of brevity) is typically presented on a display device, such as a television, as a text box overlayed on the video. The text box scrolls the words spoken in the scene in realtime in a particular language. Audio description is a separate audio track that provides narration for key visual elements in a video and is often utilized by the visually impaired. Audio description (AD) is sometimes known as video description, described video, or visual description.

To generate closed caption text or AD, the desired data is pre-generated in the desired language and streamed along with the video content of the program. The closed caption text is typically streamed as textual data and the AD is typically streamed as audio. If closed caption text or AD is desired in multiple languages, multiple versions of the program may be generated with each version including the same video content but different closed caption text or AD audio, and the appropriate copy can be streamed based on the desired closed caption or AD language. Alternatively, the video content can be generated to include closed captions and/or AD in multiple languages, however, doing so may greatly increase the size of the video content and increase network bandwidth. Generating a different version of a program for each potential closed caption or AD language can be time-consuming, expensive, requires a substantial amount of storage, and provides limited closed caption and AD options since it is impractical to generate different versions of the program for each of the hundreds of different languages commonly used throughout the world.

The examples disclosed herein implement realtime translation of communications embedded in streaming video. The term “realtime” as used herein means substantially concurrent with actual time, such as within milliseconds. In particular, a client computing device, such as a Roku® streaming device, a smart television, or the like, receives a stream of encoded packets that comprise encoded video content of a program from a streaming computing system of a video content provider, such as Netflix®, Hulu®, or the like. The client computing device receives an encoded packet in the stream of encoded packets and determines that the encoded packet includes closed caption text in a first language. The client computing device extracts, from the encoded packet, the closed caption text in the first language and causes the closed caption text in the first language to be translated to closed caption text in a second language. The client computing device generates a modified encoded packet that includes the closed caption text in the second language, and sends the modified encoded packet to a decoder for decoding and presentation on a display device, such as a television.

The examples disclosed herein greatly reduce processor utilization of a computing device because the computing device no longer needs to generate multiple versions of encoded streaming content of a program. The examples herein also greatly reduce storage requirements because multiple, such as potentially hundreds, of different versions of a program no longer need to be generated. The examples herein also increase the ability to provide communications, such as closed captions and/or AD, in a much larger number of different languages because such communications can be generated in realtime “on the fly” as the streaming content is received by a client computing device. In situations where video content is generated to include closed captions or AD in multiple languages, the examples disclosed herein greatly reduce network utilization and bandwidth because the transport stream packets no longer need to include communications in multiple languages.

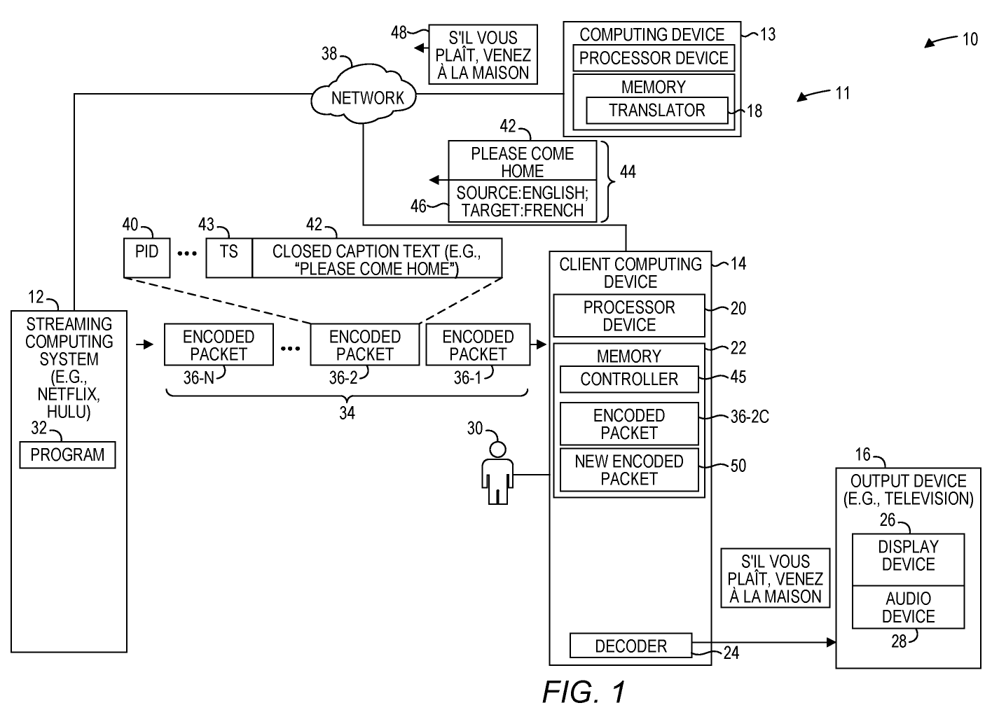

FIG. 1 is a block diagram of an environment 10 suitable for implementing realtime translation of communications embedded in streaming video according to some implementations. This implementation relates to communications comprising closed captions. The term “embedded” in this context refers to the communications being streamed in conjunction with the video content, either intermixed in the same packets with video content or in packets associated with, such as time synchronized with, the video content to which the closed captions pertain. The environment 10 includes a computing system 11 that includes a client computing device 12 and a computing device 13. The environment 10 also includes a streaming computing system 12 and an output device 16 such as, in this example, a television. The streaming computing system 12 comprises a streaming service that offers encoded streaming video content to users via a client computing device, such as the client computing device 14. The streaming computing system 12 may comprise, for example, a national service provider, a broadcast station, Netflix®, Hulu®, Amazon Prime®, or the like.

The client computing device 14 receives a stream of encoded packets comprising encoded video content of a program, such as a movie, a series, a live event, or the like. The output device 16 comprises any device that is capable of receiving and presenting video content, such as a television, a computer monitor or the like. Although shown separately, in some implementations the client computing device 14 and the output device 16 may be integrated into a single device, such as a smart television, a computer, a laptop computer, a computing tablet, a smartphone, or the like.

The environment 10 also includes a translator 18 executing on the computing device 13, the translator 18 being operable to receive text in one language and convert the text to another language. In some implementations the translator 18 is operable to receive an audio signal in a first language and translate the audio signal in the first language to text in the first language. The translator 18 is further operable to translate the text in the first language to text in the second language, and translate the text in the second language to an audio signal in the second language. Although illustrated separately in FIG. 1, in some implementations, the translator 18 may be a component of the client computing device 14.

The client computing device 14 includes a processor device 20 and a memory 22. The client computing device 14 includes a decoder 24 that is operable to receive an encoded packet, decode the packet, and render the digitized video in a format suitable for presentation on a display device 26 of the output device 16. The decoder 24 is also operable to generate audio signals from a decoded packet and provide the audio signal to an audio device 28 of the output device 16.

With this background an example of realtime translation of communications embedded in streaming video according to some implementations will be described. A user 30 interacts with the client computing device 14 to cause the client computing device 14 to communicate with the streaming computing system 12 and request a program offered by the streaming computing system 12. In an example where the client computing device 14 is a Roku® streaming device, for example, the user 30 may navigate to an application associated with the streaming computing system 12 and select a program 32 to view. In response, the client computing device 14 sends a request to the streaming computing system 12 to begin streaming the program 32.

The streaming computing system 12 begins to send a stream 34 of encoded packets 36-1 – 36-N (generally, encoded packets 36) to the client computing device 14 over one or more networks 38. The one or more networks 38 may include, for example, a cellular network, a hybrid fiber coax network, a fiber network, a local area network, the Internet, or any combination thereof. The encoded packets 36 may be streamed as individual packets, or may be aggregated into segments. The segments may be segments of a file and each segment may contain hundreds or thousands of encoded packets 36.

The stream 34 continues for the duration of the program 32. The stream of encoded packets 36 include encoded video content of the program 32. As illustrated via the encoded packet 36-2, the encoded packets 36 also include a program identifier (PID) 40 that identify the encoded packets 36 that are associated with the program 32. The encoded packets 36 may be encoded using any suitable encoding (e.g., compression) technology, such as H.262, H.264, or the like.

The encoded packets 36 may also be encrypted via a digital rights management (DRM) technology. The encoded packets 36 also include closed caption text 42 and a timestamp 43 for synchronization purposes. The closed caption text 42 may be carried in encoded packets 36 that are separate from the encoded packets 36 that carry the video content, or may be integrated with the encoded packets 36 that carry the video content. The closed caption text 42 is in a particular language, in this example, the English language.

The client computing device 14 includes a controller 45. The controller 45 receives, for example, the encoded packet 36-2 and copies the encoded packet 36-2 as an encoded packet 36-2C in the memory 22. ~The controller 45 may first decrypt the encoded packet 36-2C in accordance with a DRM encryption technology. The controller 45 verifies that the PID 40 matches the PID of the program 32, and thus that the encoded packet 36-2C is associated with the program 32. The controller 45 determines that the encoded packet 36-2C includes the closed caption text 42. The controller 45 determines, or has determined, that the user 30 prefers closed caption text in a second language, in this example French language. The controller 45 may determine this via a configuration option or setting that had previously been set by the user 30, or via user input from the user 30 via a user interface. For example, the client computing device 14, while presenting the video contents of the program 32 on the display device 26 may, in response to selection of a key of a remote control device or other user input, allow the user 30 to select a closed caption language from a list of closed caption languages. The encoded packets 36 lack closed captioning in the second language.

The controller 45 extracts, from the encoded packet 36-2C, the closed caption text 42. The controller 45 causes the closed caption text to be translated from the English language (e.g., a first language), to closed caption text in the French language (e.g., a second language). In one implementation the controller 45 causes the translation by sending the closed caption text 42 to the translator 18 via the network 38. The controller 45 may send the translator 18 a message 44 that includes closed caption text 42 and information 46 that identifies the source language of the closed caption text 42, and the desired target language of the closed caption text 42. The translator 18 receives the message 44 and translates the closed caption text 42 to generate new closed caption text 48, which, in this example, is a translation to the French language. The translator 18 sends the closed captain text 48 to the client computing device 14. In some implementations, the controller 45 may maintain a buffer of encoded packets 36 to minimize any latency that may otherwise be caused by the translation of the closed caption text 42.

The controller 45 receives the closed captain text 48 and generates a modified encoded packet 50 that includes the closed caption text 48, the PID 40 and the timestamp 43. The timestamp 43 may be used for time synchronization purposes to time synchronize the modified encoded packet 50 with the corresponding video content in an encoded packet 36. The modified encoded packet 50 may not include the closed caption text 42. The modified encoded packet 50 may be a different packet than the encoded packet 36-2C as illustrated in FIG. 1, or may be an altered encoded packet 36-2C. In the situation where the modified encoded packet 50 is a different packet than the encoded packet 36-2C the controller 45 may discard the encoded packet 36-2C. The controller 45 sends the modified encoded packet 50 to the decoder 24 for decoding.

The decoder 24 decodes the modified encoded packet 50 in accordance with the particular encoding technology, and presents, on the display device 26, the closed caption text 48 concurrently with video content of the program 32 obtained either from the modified encoded packet 50 or another encoded packet 36 that is time-synchronized with the timestamp 43 of the modified encoded packet 50.

It is noted that, because the controller 45 is a component of the client computing device 14, functionality implemented by the controller 45 may be attributed to the client computing device 14 generally. Moreover, in examples where the controller 45 comprises software instructions that program the processor device 20 to carry out functionality discussed herein, functionality implemented by the controller 45 may be attributed herein to the processor device 20.

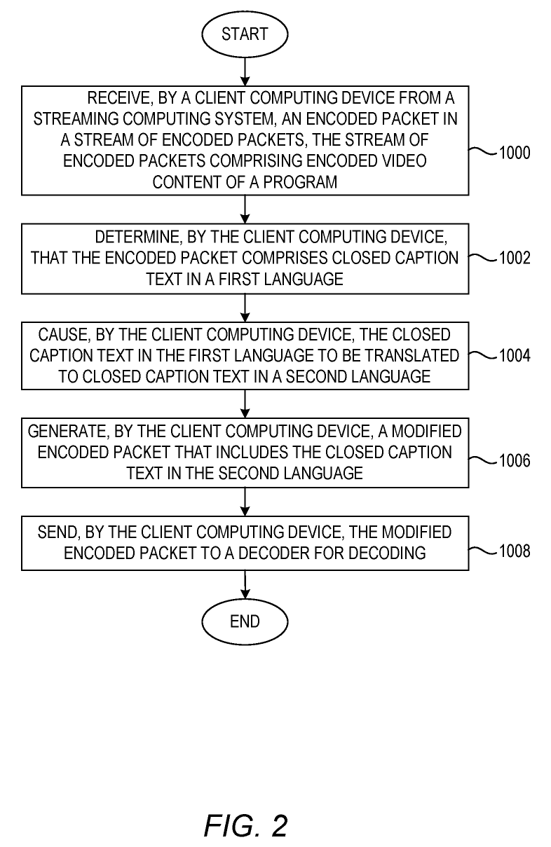

FIG. 2 is a flowchart of a method for implementing realtime translation of communications embedded in streaming video according to some implementations. FIG. 2 will be discussed in conjunction with FIG. 1. The client computing device 14 receives, from the streaming computing system 12, the encoded packet 36-2 in the stream 34 of encoded packets 36, the stream 34 of encoded packets 36 comprising encoded video content of the program 32 (FIG. 2, block 1000). The client computing device 14 determines that the encoded packet 36-2 comprises the closed caption text 42 in the first language, in this example, the English language (FIG. 2, block 1002). The client computing device 14 causes the closed caption text 42 in the first language to be translated to the closed caption text 48 in the second language (FIG. 2, block 1004). In one non-limiting example, the client computing device 14 extracts the closed caption text 42 from the encoded packet 36-2 and sends the closed caption text 42 to the translator 18 for translation. The client computing device 14 generates the modified encoded packet 50 that includes the closed caption text 48 in the second language (FIG. 2, block 1006). The client computing device 14 sends the modified encoded packet 50 to the decoder 24 for decoding (FIG. 2, block 1008).

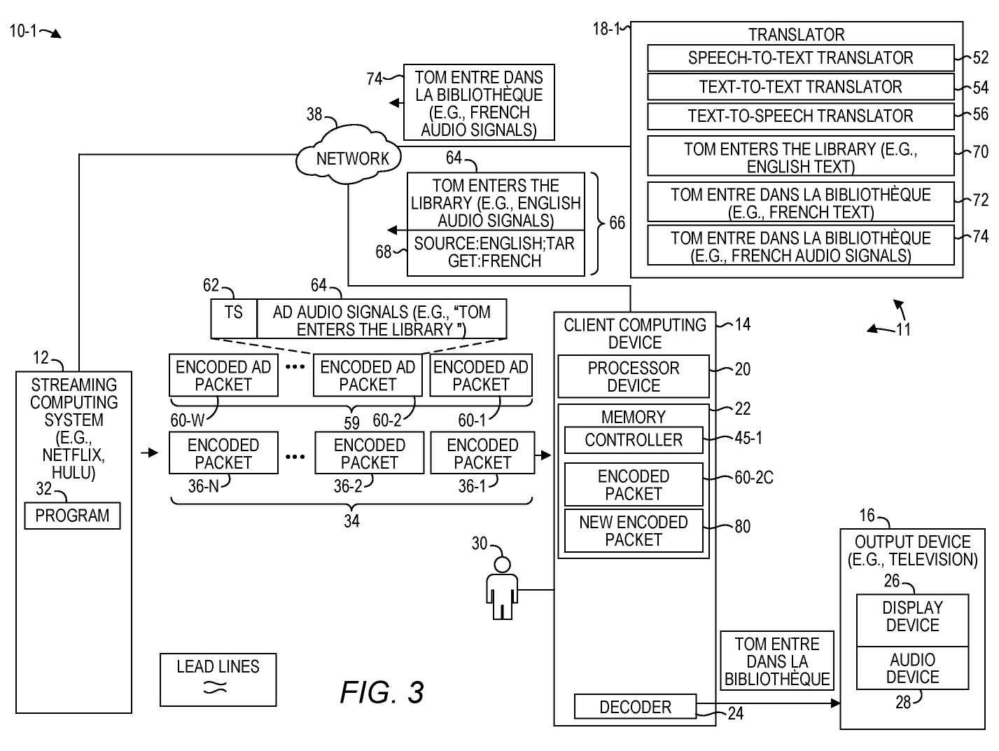

FIG. 3 is a block diagram of an environment 10-1 suitable for implementing realtime translation of communications embedded in streaming video according to another implementation. The environment 10-1 is substantially similar to the environment 10 except as otherwise discussed herein. This implementation relates to communications comprising audio description. Audio description is typically an audio track that provides narration for key visual elements in a video program and is often utilized by the visually impaired. Audio description (AD) is sometimes known as video description, described video, or visual description. The AD is typically provided as a separate file from the encoded packets carrying the video content. The AD may be arranged in encoded audio packets, such as, by way of non-limiting example, MP3 or WAV packets, which include timestamps that synchronize the AD in an encoded audio packet with corresponding video content in encoded video packet(s).

The environment 10-1 also includes a translator 18-1 that includes a speech-to-text translator 52 that is operable to receive an encoded audio packet comprising digitized audio in a first language and translate the digitized audio to text in the first language. Due to spatial limitations, the computing device 13 has been omitted from FIG. 3. The translator 18-1 also includes a text-to-text translator 54 operable to translate the text in the first language to text in a second language. The translator 18-1 includes a text-to-speech translator 56 operable to translate the text in the second language to digitized audio in the second language.

With this background an example of realtime translation of communications embedded in streaming video according to another implementation will be described. The user 30 interacts with the client computing device 14 to cause the client computing device 14 to communicate with the streaming computing system 12 and request the program 32 offered by the streaming computing system 12. The streaming computing system 12 begins to send the stream 34 of encoded packets 36-1 – 36-N to the client computing device 14 over the one or more networks 38. The stream 34 continues for the duration of the program 32. The stream of encoded packets 36 include encoded video content of the program 32.

As the client computing device 14 presents the video contents of the program 32 on the display device 26 the user 30 may interact with the client computing device 14 by, for example, manipulating a remote control device that sends signals to the client computing device 14. In response to a selection by the user 30, the client computing device 14 presents a list of AD languages on the display device 26 for selection by the user 30. In this example, the user 30 selects the French language. In response, the client computing device 14 sends a request to the streaming computing system 12 to provide AD for the program 32. The streaming computing system 12 accesses an AD file that corresponds to the program 32. In this example, the only AD file that corresponds to the program 32 is in the English language.

The streaming computing system 12 initiates a stream 59 of encoded AD packets 60-1, 60-2 – 60-W (generally, encoded AD packets 60) to the client computing device 14. As illustrated by the encoded AD packet 60-2, each encoded AD packet 60 may include a timestamp 62 and AD audio signals 64 (sometimes referred to as audio signals 64 for the sake of brevity). The encoded AD packets 60 may also include the same PID as that of the encoded packets 36. The timestamp 62 is for synchronizing the AD audio signals 64 with the corresponding video content in the encoded packets 36 so that the AD audio signals 64 contains audio that, when played on the audio device 28, corresponds to the video content being presented on the display device 26. The encoded packets 36 may be streamed as individual packets, or may be aggregated into segments. The segments may be segments of a file that, such that each segment contains hundreds or thousands of encoded packets 60.

The client computing device 14 includes a controller 45-1. The controller 45-1 may implement substantially similar functionality as discussed above with regard to the controller 45, and additional functionality as discussed herein. The controller 45-1 receives the encoded AD packet 60-2 and copies the encoded AD packet 60-2 as an encoded AD packet 60-2C in the memory 22. The controller 45-1 may first decrypt the encoded AD packet 60-2C in accordance with a DRM encryption technology. The controller 45-1 may verify that a PID in the encoded AD packet 60-2C matches the PID of the program 32, and thus that the encoded AD packet 60-2C is associated with the program 32.

The controller 45-1 extracts, from the encoded AD packet 60-2C, the AD audio signals 64. The controller 45-1 causes the AD audio signals 64 to be translated to text in a first language, in this example, to text in the English language. In one implementation the controller 45-1 causes the translation by sending the AD audio signals 64 to the translator 18-1 via the network 38. The controller 45-1 may send the translator 18-1 a message 66 that includes the AD audio signals 64 and information 68 that identifies the source language of the AD audio signals 64, in this example English, and the desired target language, in this example French. The translator 18-1 receives the message 66 and processes the AD audio signals 64 with the speech-to-text translator 52 to generate text 70 in the English language.

The translator 18-1 may then process the text 70 with the text-to-text translator 54 to translate, or convert, the text in the English language to text 72 in the French language. The translator 18-1 may then process the text 72 with the text-to-speech translator 56 to translate, or convert, the text 72 to audio signals 74 in the French language. The translator 18 sends the audio signals 74 to the client computing device 14. In some implementations, the controller 45-1 may maintain a buffer of encoded packets 60 to minimize any latency that may otherwise be caused by the translation of the AD in the encoded AD packets 60.

The controller 45-1 receives the audio signals 74 and generates a modified encoded packet 80 that includes the audio signals 74, optionally the PID, and the timestamp 62. The modified encoded packet 80 may not include the AD audio signals 64. The modified encoded packet 80 may be a different packet than the encoded packet 60-2C as illustrated in FIG. 3, or may be an altered encoded packet 60-2C. In the situation where the modified encoded packet 80 is a different packet than the encoded packet 60-2C the controller 45-1 may discard the encoded packet 60-2C. The controller 45-1 sends the modified encoded packet 80 to the decoder 24 for decoding.

The decoder 24 decodes the modified encoded packet 80 in accordance with the particular encoding technology, and presents, via the audio device 28, the audio signals 74 concurrently while presenting video content of the program 32 obtained from an encoded packet 36 that is time-synchronized with the audio signals 74.

It is noted that, because the controller 45-1 is a component of the client computing device 14, functionality implemented by the controller 45-1 may be attributed to the client computing device 14 generally. Moreover, in examples where the controller 45-1 comprises software instructions that program the processor device 20 to carry out functionality discussed herein, functionality implemented by the controller 45-1 may be attributed herein to the processor device 20.

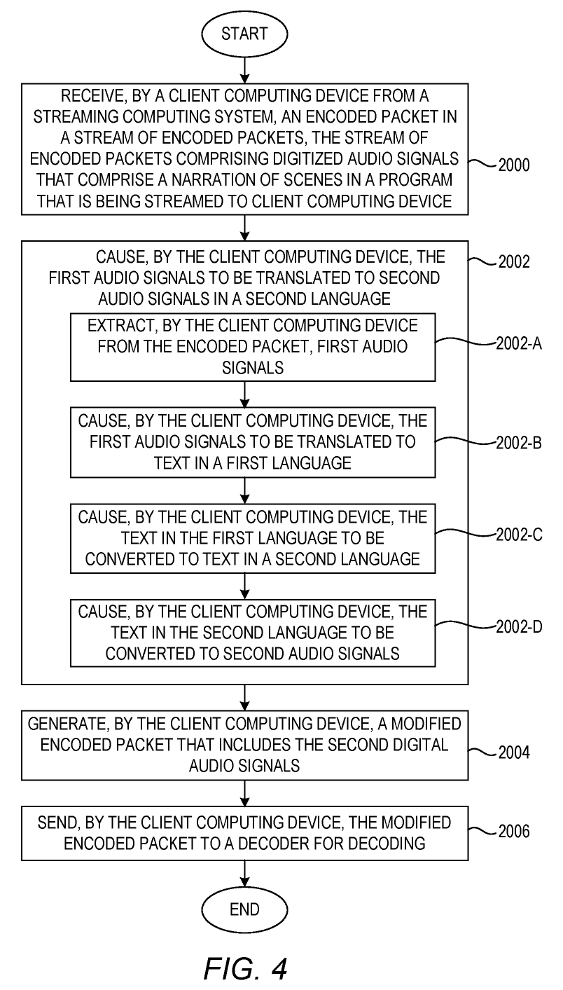

FIG. 4 is a flowchart of a method for implementing realtime translation of communications embedded in streaming video according to another implementation. FIG. 4 will be discussed in conjunction with FIG. 3. The client computing device 14 receives, from the streaming computing system 12, the encoded packet 60-2 in the stream 59 of encoded packets 60, the stream 59 of encoded packets 60 comprising digitized audio signals that comprise a narration of scenes in the program 32 that is being streamed to the client computing device 14 (FIG. 4, 2000).

The client computing device 14 causes the audio signals 64 in the first language to be translated to the audio signals 74 in the second language (FIG. 4, 2002). The client computing device 14 may cause such translation in any suitable manner. In one non-limiting example, the client computing device 14 extracts, from the encoded packet 60-2C, the audio signals 64 (FIG. 4, 2002-A). The client computing device 14 causes, via the translator 18-1, the audio signals 64 to be translated to the text 70 in the English language (FIG. 4, 2002-B). The client computing device 14 causes, via the translator 18-1, the text 70 in the English language to be converted to the text 72 in the French language (FIG. 4, 2002-C). The client computing device 14 causes, via the translator 18-1, the text 72 in the French language to be converted to the audio signals 74 in the French language (FIG. 4, 2002-D).

The client computing device 14 generates the modified encoded packet 80 that includes the audio signals in the French language (FIG. 4, 2010). The client computing device 14 sends the modified encoded packet 80 to the decoder 24 for decoding (FIG. 4, 2012).

It is noted that in other implementations the functionality described herein with regard to the translators 18 and 18-1 may be incorporated into the client computing device 14 rather than being implemented in the computing device 13. Moreover, while for purposes of illustration the realtime translation of closed captions and AD audio signals have been described as separate implementations, in other implementations both closed captions and AD audio signals can be realtime translated in parallel and presented to the user 30 concurrently.

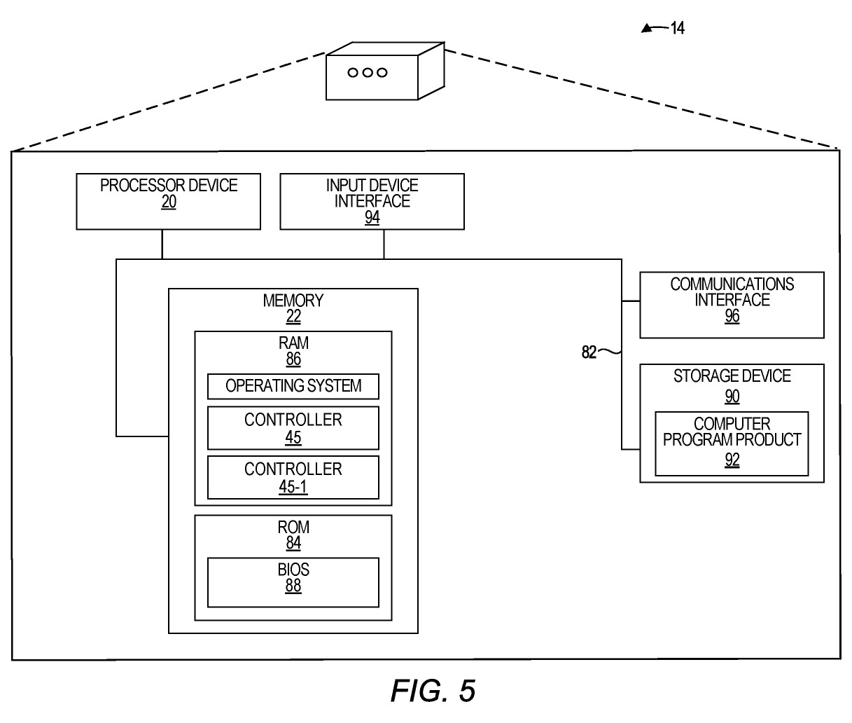

FIG. 5 is a block diagram of the client computing device 14 suitable for implementing examples disclosed herein according to one example. The client computing device 14 may comprise any computing or electronic device capable of including firmware, hardware, and/or executing software instructions to implement the functionality described herein, such as a desktop computing device, a laptop computing device, a smartphone, a streaming device such as a Roku® streaming device, a smart television or the like. The client computing device 14 includes the processor device 20, the system memory 22, and a system bus 82. The system bus 82 provides an interface for system components including, but not limited to, the system memory 22 and the processor device 20. The processor device 20 can be any commercially available or proprietary processor.

The system bus 82 may be any of several types of bus structures that may further interconnect to a memory bus (with or without a memory controller), a peripheral bus, and/or a local bus using any of a variety of commercially available bus architectures. The system memory 22 may include non-volatile memory 84 (e.g., read-only memory (ROM), erasable programmable read-only memory (EPROM), electrically erasable programmable read-only memory (EEPROM), etc.), and volatile memory 86 (e.g., random-access memory (RAM)). A basic input/output system (BIOS) 88 may be stored in the non-volatile memory 84 and can include the basic routines that help to transfer information between elements within the client computing device 14. The volatile memory 86 may also include a high-speed RAM, such as static RAM, for caching data.

The client computing device 14 may further include or be coupled to a non-transitory computer-readable storage medium such as a storage device 90, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 90 and other drives associated with computer-readable media and computer-usable media may provide non-volatile storage of data, data structures, computer-executable instructions, and the like.

A number of modules can be stored in the storage device 90 and in the volatile memory 86, including an operating system and one or more program modules, such as the controller 45 and/or the controller 45-1, which may implement the functionality described herein in whole or in part. All or a portion of the examples may be implemented as a computer program product 92 stored on a transitory or non-transitory computer-usable or computer-readable storage medium, such as the storage device 90, which includes complex programming instructions, such as complex computer-readable program code, to cause the processor device 20 to carry out the steps described herein. Thus, the computer-readable program code can comprise software instructions for implementing the functionality of the examples described herein when executed on the processor device 20. The processor device 20, in conjunction with the controllers 45, 45-1 in the volatile memory 86, may serve as a controller, or control system, for the client computing device 14 that is to implement the functionality described herein.

An operator, such as the user 30, may also be able to enter one or more configuration commands through a keyboard (not illustrated), a pointing device such as a mouse (not illustrated), or a touch-sensitive surface such as a display device. Such input devices may be connected to the processor device 20 through an input device interface 94 that is coupled to the system bus 82 but can be connected by other interfaces such as a parallel port, an Institute of Electrical and Electronic Engineers (IEEE) 1394 serial port, a Universal Serial Bus (USB) port, an IR interface, and the like. The client computing device 14 may also include a communications interface 96, such as an Ethernet transceiver and/or a Wi-Fi transceiver, or the like, suitable for communicating with the network 38 as appropriate or desired.

Individuals will recognize improvements and modifications to the preferred examples of the disclosure. All such improvements and modifications are considered within the scope of the concepts disclosed herein and the claims that follow.

What is claimed is:

1. A method, comprising:
receiving, by a client computing device from a streaming computing system, an encoded packet in a stream of encoded packets, the stream of encoded packets comprising encoded video content of a program;
determining, by the client computing device, that the encoded packet comprises closed caption text in a first language;
causing, by the client computing device, the closed caption text in the first language to be translated to closed caption text in a second language;
generating, by the client computing device, a modified encoded packet that includes the closed caption text in the second language; and
sending, by the client computing device, the modified encoded packet to a decoder for decoding.

2. The method of claim 1, wherein the modified encoded packet is a new encoded packet, and further comprising discarding, by the client computing device, the encoded packet.

3. The method of claim 1, further comprising:
determining the first language;
determining, by the client computing device, the second language; and
wherein causing the closed caption text in the first language to be translated to closed caption text in a second language further comprises:
extracting, by the client computing device from the encoded packet, the closed caption text in the first language; and
sending, by the client computing device to a translation process, the closed caption text in the first language, a first language identifier that identifies the first language, and a second language identifier that identifies the second language.

4. The method of claim 3, wherein determining the second language comprises receiving, by the client computing device, user input that identifies the second language.

5. The method of claim 3, wherein determining the first language comprises determining, by the client computing device, the first language based on content in the encoded packet.

6. The method of claim 1, further comprising:
decoding, by the decoder, the modified encoded packet; and
presenting, by the decoder on a display device, video content and the closed caption text in the second language concurrently on a display device.

7. The method of claim 1, wherein the encoded packet includes a timestamp, and further comprising:
storing, by the client computing device, the timestamp in the modified encoded packet that includes the closed caption text in the second language.

8. The method of claim 1, wherein the stream of encoded packets lacks closed captions in the second language.

9. A computing system, comprising:
one or more computing devices operable to:
receive, from a streaming computing system, an encoded packet in a stream of encoded packets, the stream of encoded packets comprising encoded video content of a program;
determine that the encoded packet comprises closed caption text in a first language;
cause the closed caption text in the first language to be translated to closed caption text in a second language;
generate a modified encoded packet that includes the closed caption text in the second language; and
send the modified encoded packet to a decoder for decoding.

10. The computing system of claim 9, wherein the modified encoded packet is a new encoded packet, and further comprising discarding, by the one or more computing devices, the encoded packet.

11. The computing system of claim 9, wherein the one or more computing devices are further operable to:
determine the first language;
determine the second language; and
wherein to cause the closed caption text in the first language to be translated to closed caption text in a second language, the one or more computing devices are further operable to:
extract, from the encoded packet, the closed caption text in the first language;
send, to a translation process, the closed caption text in the first language, a first language identifier that identifies the first language, and a second language identifier that identifies the second language.

12. The computing system of claim 11, wherein to determine the second language the one or more computing devices are further operable to:
receive user input that identifies the second language.

13. The computing system of claim 11, wherein to determine the first language the one or more computing devices are further operable to determine the first language based on content in the encoded packet.

14. The computing system of claim 9, wherein the one or more computing devices are further operable to:
decode, by the decoder, the modified encoded packet; and
present, by the decoder on a display device, video content and the closed caption text in the second language concurrently on a display device.

15. The computing system of claim 9, wherein the encoded packet includes a timestamp, and wherein the one or more computing devices are further operable to store the timestamp in the modified encoded packet that includes the closed caption text in the second language.

16. A method, comprising:
receiving, by a client computing device from a streaming computing system, an encoded packet in a stream of encoded packets, the stream of encoded packets comprising digitized audio signals that comprise a narration of scenes in a program that is being streamed to the client computing device;
causing, by the client computing device, the first audio signals to be translated to second audio signals in a second language;
generating, by the client computing device, a modified encoded packet that includes the second audio signals; and
sending, by the client computing device, the modified encoded packet to a decoder for decoding.

17. The method of claim 16, wherein causing, by the client computing device, the first audio signals to be translated to second audio signals in a second language further comprises:
extracting, by the client computing device from the encoded packet, first audio signals in a first language;
causing, by the client computing device, the first audio signals to be translated to text in the first language;
causing, by the client computing device, the text in the first language to be converted to text in a second language; and
causing, by the client computing device, the text in the second language to be converted to the second audio signals.

18. The method of claim 17, further comprising:
determining the first language;
determining, by the client computing device, the second language; and
wherein causing the first audio signals to be translated to text in the first language comprises:
sending, by the client computing device to a translation process, the first audio signals, a first language identifier that identifies the first language, and a second language identifier that identifies the second language.

19. The method of claim 18, wherein determining the second language comprises:
receiving, by the client computing device, user input that identifies the second language.

20. The method of claim 16 further comprising:
decoding, by the decoder, the modified encoded packet; and
presenting, by the decoder on a display device, audio in the second language on an audio device.
